(19) United States
(12) Patent Application Publication
(10) Pub. No.: US 2009/0088486 A1
(43) Pub. Date: Apr. 2, 2009

(54) ECONOMICALLY EFFICIENT PROCESS OF SYNTHESIZING POROUS POLYMERIC MATERIALS

(75) Inventors: Jianzhong Lou, Greensboro, NC (US); Arvind Vyas Harinath, Greensboro, NC (US)

Correspondence Address: MYERS BIGEL SIBLEY & SAJOVEC, PO BOX 37428, RALEIGH, NC, 27627, US

(73) Assignee: North Carolina Agricultural and Technical State University

(21) Appl. No.: 12/240,418

(22) Filed: Sep. 29, 2008

Related U.S. Application Data
(60) Provisional application No. 60/976,119, filed on Sep. 28, 2007.

(51) Int. Cl. C08J 9/26

(52) U.S. Cl. 521/61

(57) ABSTRACT

The present invention provides processes for the synthesis of porous polymeric materials. The processes provide low cost and/or less complicated methods of controlling pore size distribution in polymeric materials.

### RELATED APPLICATION DATA

This application claims priority to and the benefit of U.S. Patent Application Ser. No. 60/976,119, filed Sep. 28, 2007, the disclosure of which is incorporated by reference herein in its entirety.

### FIELD OF THE INVENTION

The present invention generally concerns a method of forming porous polymeric materials.

### BACKGROUND OF THE INVENTION

There are numerous industrial applications, for example, ultrafiltration membranes for drug purification, water treatment, juice clarification, diaper film breathability, entrapment of enzymes in spiral sheet bioreactors and drug delivery devices, that involve the use of porous polymeric materials. There is a need for a less complicated and/or less expensive methods of forming such porous polymeric materials.

### SUMMARY OF THE INVENTION

The present invention provides methods of forming pores, such as nanopores and micropores in polymeric materials, controlling pore size distribution and affecting the interconnectivity of pores as well forming pores to form channels in polymeric materials.

In particular, an aspect of the present invention relates to processes for the synthesis of a polymeric material including (a) mixing a solid filler in a polymer solution, wherein the filler is not dissolved in the polymer solution, to form a polymer film including solid fillers embedded within the polymer film; and (b) removing the solid filler using a solvent that selectively dissolves the solid filler to a greater extent than the polymer of the polymer solution, to provide a polymeric material.

Another aspect of the present invention relates to processes for the synthesis of a polymeric material including (a) mixing at least two immiscible polymers to create a phase-separated polymer blend using a ratio between the at least two polymers to form a minor phase including isolated regions and a major phase having a continuous morphology; and (b) removing the minor phase using a solvent that selectively dissolves the polymer of the minor phase to a greater extent than the polymer of the major phase, to provide a polymeric material.

The methods of forming the polymeric materials described herein can provide less complicated and/or less expensive methods of forming such porous polymeric materials. These polymeric materials can be used in industrial applications that include, but are not limited to, ultrafiltration membranes for drug purification, water treatment, juice clarification, diaper film breathability, entrapment of enzymes in spiral sheet bioreactors and drug delivery devices.

### DETAILED DESCRIPTION

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. As used herein, the term “and/or” includes any and all combinations of one or more of the associated listed items.

Unless otherwise defined, all technical and scientific terms used herein have the same meaning as commonly understood by one of ordinary skill in the art to which this invention belongs.

It will be understood that steps comprising the methods provided herein can be performed independently or at least two steps can be combined when the desired outcome can be obtained.

Embodiments of the present invention may utilize solvent-soluble solid fillers of controlled size distribution to be embedded in the process of polymer film formation, such as admixing fillers and polymer solutions such that the fillers do not dissolve in the polymer solutions and before the film forming step. After film forming, the film includes the solid fillers embedded within, either interconnected or not interconnected based on the population density of the fillers inside the polymer, above or below the percolation threshold. The solid fillers can be removed by dissolving the fillers in a solvent that preferentially dissolves the solid fillers and does not significantly change the remaining structure of the polymer. The interconnected pores can form channels. In particular embodiments, the channels allow molecular transport through the polymer host.

Accordingly, embodiments of the present invention provide processes for the synthesis of a polymeric material comprising: (a) mixing a solid filler in a polymer solution, wherein the filler is not dissolved in the polymer solution, to form a polymer film comprising solid fillers embedded within the polymer film; and (b) removing the solid filler using a solvent that selectively dissolves the solid filler to a greater extent than the polymer of the polymer solution to provide a polymeric material. In some embodiments, the solid filler is completely removed. In other embodiments, greater than 95% of the solid filler is removed. In further embodiments, the solid filler is a salt, for example, sodium chloride. In further embodiments, the polymer solution includes a polyester. Polyesters suitable for use according to the present invention include, but are not limited to, polylactic acid (PLA) and polycarbonate (PC). In still further embodiments, the solid fillers embedded within the polymer film are interconnected whereas in other embodiments, the solid fillers embedded within the polymer film are not interconnected. In some embodiments, the solid fillers embedded within the polymer film form pores, such as micropores or nanopores, and in other embodiments, the solid fillers embedded within the polymer film form channels.

Embodiments of the present invention further provide a process for the synthesis of a polymeric material comprising: (a) mixing at least two immiscible polymers to create a phase-separated polymer blend using a ratio between the at least two polymers to form a minor phase comprising isolated regions and a major phase comprising a continuous morphology; and (b) removing the minor phase using a solvent that selectively dissolves the polymer comprising the minor phase to a greater extent than the polymer comprising the major phase to provide a polymeric material.

In some embodiments of the present invention, the isolated regions of the minor phase are interconnected. In other embodiments, the isolated regions of the minor phase are not interconnected. In some embodiments, the isolated regions of the minor phase form pores, such as micropores or nanopores, whereas in other embodiments, the isolated regions of the minor phase form channels.

Embodiments of the present invention will be further explained with reference to the following example, which is included herein for illustration purposes only, and which is not intended to be limiting of the invention.

### EXAMPLE

### Process for the Economic Synthesis of a Polymeric Material

A finely ground salt (NaCl) was mixed into a polymer, polylactic acid (PLA), and a thin sheet was formed using a film casting process. The resulting product was then dissolved in water at room temperature to create micro-pores and interconnected micro-pores, i.e., channels, in the PLA film. The structure of the film, in particular formation of the channels, was verified using an optical microscope.

The foregoing is illustrative of the present invention, and is not to be construed as limiting thereof. The invention is defined by the following claims, with equivalents of the claims to be included therein.

That which is claimed is:

1. A process for the synthesis of a polymeric material comprising:
(a) mixing a solid filler in a polymer solution, wherein the filler is not dissolved in the polymer solution, to form a polymer film comprising solid fillers embedded within the polymer film; and
(b) removing the solid filler using a solvent that selectively dissolves the solid filler to a greater extent than the polymer of the polymer solution, to provide a polymeric material.

2. The process of claim 1, wherein the solid filler is a salt.

3. The process of claim 1, wherein the solid filler is sodium chloride.

4. The process of claim 1, wherein the polymer solution comprises a polyester.

5. The process of claim 4, wherein the polyester is polylactic acid (PLA).

6. The process of claim 1, wherein the solid fillers embedded within the polymer film are interconnected.

7. The process of claim 1, wherein the solid fillers embedded within the polymer film are not interconnected.

8. The process of claim 1, wherein the solid fillers embedded within the polymer film form pores.

9. The process of claim 1, wherein the solid fillers embedded within the polymer film form channels.

10. A process for the synthesis of a polymeric material comprising:
(a) mixing at least two immiscible polymers to create a phase-separated polymer blend using a ratio between the at least two polymers to form a minor phase comprising isolated regions and a major phase comprising a continuous morphology; and
(b) removing the minor phase using a solvent that selectively dissolves the polymer comprising the minor phase to a greater extent than the polymer comprising the major phase, to provide a polymeric material.

11. The process of claim 10, wherein the isolated regions of the minor phase are interconnected.

12. The process of claim 10, wherein the isolated regions of the minor phase are not interconnected.

13. The process of claim 10, wherein the isolated regions of the minor phase form pores.

14. The process of claim 10, wherein the isolated regions of the minor phase form channels.
